(19) United States
(12) Patent Application Publication
(10) Pub. No.: US 2004/0104961 A1
(43) Pub. Date: Jun. 3, 2004

(54) Recovery device for ink jet printer

(75) Inventors: Hiroshi Hashi, Tokyo (JP); Toshihiro Kitahara, Tokyo (JP); Fujio Kosaka, Tokyo (JP); Katsunori Kumai, Tokyo (JP); Takumi Sugaya, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 10/691,804

(22) Filed: Oct. 21, 2003

Related U.S. Application Data
(63) Continuation of application No. PCT/JP02/05254, filed on May 30, 2002.

(30) Foreign Application Priority Data
May 31, 2001 (JP) 2001-165225

(51) Int. Cl. B41J 2/165

(52) U.S. Cl. 347/29; 347/33

(57) ABSTRACT

A recovery device for an ink jet printer includes a recovery unit having a wiper and a cap. When performing recovery processing, the recovery unit is inserted into a lower portion of a print head. The wiper moves along the +Y direction above the cap in a retreated state, and wipes the ink discharge surface of the print head. Also, in a state where the wiper is retreated outside the moving locus of the cap, the cap moves upward and caps the ink discharge surface of the print head. In this capping state, discharging and sucking of ink are performed for cleaning. This recovery device for an ink jet printer has a simple structure, and allows the suction of discharged ink during recovery processing to be efficiently performed. Furthermore, the present recovery device has a smaller space required for placement, thereby enabling the size-reduction of a printer apparatus.

### TECHNICAL FIELD

The present invention relates to a recovery device that performs maintenance processing, such as cleaning and capping, of an ink discharge surface of a print head in an ink jet printer.

### BACKGROUND ART

Hitherto, as a proposal related to a recovery device in an ink jet printer, Japanese Unexamined Patent Application Publication No. 2-179757 discloses an ink jet printer apparatus incorporating a cleaning device. This ink jet printer includes a head unit for long length printing, and a blade section and cap section for cleaning. The cleaning of the head surface of the head unit is performed by retreating the head unit from a printing position, and bringing the blade section into a sliding contact with the head surface of the head unit. The cap section, which is a cover member for covering the head surface in the retreated state, incorporates the entirety of the blade section having a feed-screw section, and has a cap shape with a size enough to completely cover the head surface. During a printing operation, this cap section is in a state moved to a position retreated from the head unit, together with the blade section.

However, in the ink jet printer apparatus disclosed in the Japanese Unexamined Patent Application Publication No. 2-179757, the cap section of its recovery device has a size enough to cover the entire head, and the entirety of the blade section and its-feed-screw. When printing is to be performed, it is necessary to retreat the recovery device comprising the blade section and cap section. This has disadvantageously increased the external dimension of the printer apparatus in a considerable degree. Also, the moving distance of the recovery device has been long, and the moving route thereof has been complicated. In particular, this recovery device has been unsuited to a printer apparatus capable of page width printing such as A3 size (JIS standards) or the like. Furthermore, the driving of the blade in the blade section for cleaning the head surface has been limited to the reciprocation of the blade along the nozzle row direction of the head, and no thought has been given to shortening a cleaning time in consideration of the layout of the blade.

An ink jet printer apparatus disclosed in Japanese Unexamined Patent Application Publication No. 8-150727 is a printer to which a plurality of long-length type print heads is applied. When performing recovery processing of the head surface of a print head in this printer apparatus, ink is discharged into a cap in a downward direction, with the head surface of the print head covered by a cap, and the ink is sucked from inside the cap, thereby performing the recovery processing of a nozzle section of the head surface.

However, in the ink jet printer apparatus disclosed in the Japanese Unexamined Patent Application Publication No. 8-150727, because there is provided only a single ink suction hole in a cap member, it has been difficult to efficiently suck and remove ink accumulated in the cap. Particularly when applying this ink suction hole to a long-length type head, the removal of ink has been more difficult.

Also, an ink jet printer apparatus disclosed in Japanese Unexamined Patent Application Publication No. 5-16375 includes a cap member, cap drive mechanism section, and suction pump, as members for performing recovery processing of the head surface of a print head. When performing recovery processing, the head surface is covered by the cap member. In this state, ink is ejected from nozzles in the surface of the head to remove the clogging of the nozzles. Ink accumulated in the cap member is sucked by the suction pump and removed.

However, also in the ink jet printer apparatus disclosed in the Japanese Unexamined Patent Application Publication No. 5-16375, it has been difficult to efficiently suck all of the ink accumulated in the cap, particularly on the right and left sides thereof.

The present invention has been made to solve the above-described problems, and the object thereof is to provide a recovery device for an ink jet printer, the recovery device having a simple structure, allowing the suction of discharged ink during-recovery processing to be efficiently performed, having a smaller space required for placement, and thereby enabling the size-reduction of a printer apparatus.

### DISCLOSURE OF INVENTION

In one aspect of the present invention, there is provided a recovery device for an ink jet printer. This recovery device includes a wiper means that wipes each of ink discharge surfaces of print heads that discharge ink, and a cap means that caps each of the ink discharge surfaces. The recovery device is disposed so that the wiper means and the cap means at least partially overlap each other, as seen from the ink discharge direction of the print head. When the cap means caps the ink discharge surface of the print head, the cap is located at its capping position opposite to the ink discharge surface of the print head. On the other hand, when the ink discharge surface of the print head is wiped by the wiper means, the cap means is located at its retreat position spaced apart from the ink discharge surface.

In another aspect of the present invention, there is provided a recovery device for an ink jet printer, the recovery device having a cap member capable of covering an ink discharge surface of a print head that discharges ink in a downward direction. In this cap member, an ink suction hole for sucking ink discharged on the surface of the cap opposite to the print head, is disposed in equal position with respect to a nozzle area of the print head.

In still another aspect of the present invention, there is provided a recovery device for an ink jet printer, the recovery having a cap capable of covering an ink discharge surface of a print head that discharges ink in a downward direction. This cap has an ink suction hole for sucking ink discharged or sucked on the surface of the cap opposite to the print head. An inclined surface such that the ink suction hole portion assumes the lowest position on the surface of the cap opposed to the print head during at least one period of time in a sucking process by the cap, is formed on the surface of the cap opposed to the head.

### BRIEF DESCRIPTION OF THE DRAWINGS

FIG. 1 is a layout view showing the main construction of an ink jet printer according to an embodiment of the present invention.

FIG. 2 is an exploded perspective view of a head device applied to the ink jet printer in FIG. 1.

FIG. 3 is an enlarged view showing the arrangement of ink discharge nozzle rows when printing heads constituting a head block of a head device of the ink jet printer in FIG. 1 is seen from the B direction in FIG. 2.

FIG. 4 is a sectional view of a recovery unit of a recovery device incorporated in the ink jet printer in FIG. 1, as seen from the A-A direction in FIG. 1, wherein a wiping mechanism section of the aforementioned recovery unit is located at its retreat position (the wiping start position), as well as a cap mechanism section of the recovery unit is located at its retreat position.

FIG. 5 is a sectional view of the recovery unit of the recovery device incorporated in the ink jet printer in FIG. 1, as seen from the A-A direction in FIG. 1, wherein the cap mechanism section is located at its capping position.

FIG. 6 is a plan view of the recovery unit in the ink jet printer in FIG. 1, wherein a wiping process is illustrated.

FIG. 7 is a plan view of the recovery unit in the ink jet printer in FIG. 1, wherein a returning process of the wiper is illustrated.

FIG. 8 is an exploded perspective view of the wiper mechanism section of the recovery unit in the ink jet printer in FIG. 1.

FIG. 9 is a D arrow view of FIG. 8, wherein a turning movement of the wiper support member in the wiper mechanism section is illustrated.

FIG. 10 is a sectional view of the recovery unit as seen from the A-A direction in FIG. 1, wherein a retreated state of the wiper mechanism section in an upright posture is illustrated.

FIG. 11 is a sectional view of the recovery unit as seen from the A-A direction in FIG. 1, wherein a wiping operation of the wiper mechanism section is illustrated.

FIG. 12 is a sectional view of the recovery unit as seen from the A-A direction in FIG. 1, wherein a horizontally retreated state of the wiper mechanism section is illustrated.

FIG. 13 is a sectional view of the recovery unit as seen from the A-A direction in FIG. 1, wherein a returning process of the wiper mechanism section while remaining in the horizontally retreated state, is illustrated.

FIG. 14 is a longitudinal sectional view of the cap mechanism section of the recovery unit in the ink jet printer in FIG. 1, wherein a retreated state is illustrated in which the cap mechanism section is retreated from a print head.

FIG. 15 is a longitudinal sectional view of the cap mechanism section of the ink jet printer in FIG. 1, wherein a capping state is illustrated in which a cap covers the print head.

FIG. 16A is an E arrow view of FIG. 14, wherein the shape of the cap in the cap mechanism section of the ink jet printer in FIG. 1 is illustrated, and FIG. 16B is a G-G sectional view of FIG. 16A.

FIG. 17 is an enlarged view showing an ink discharge surface to be capped by the cap mechanism section of the ink jet printer in FIG. 1.

FIG. 18 is a sectional view of the cap when the ink discharge surface is capped by the cap mechanism section of the ink jet printer in FIG. 1.

FIG. 19 is a longitudinal sectional view of a cap mechanism section of a first modification to the cap mechanism section applied to the ink jet printer in FIG. 1, wherein a capping state of the cap mechanism section of the first modification is illustrated.

FIG. 20A is an H arrow view of FIG. 19, wherein the shape of a cap in the cap mechanism section of the first modification is illustrated, and FIG. 20B is a I-I sectional view of FIG. 20A.

FIG. 21 is a longitudinal sectional view of a cap mechanism section of a second modification to the cap mechanism section applied to the ink jet printer in FIG. 1, wherein a capping state of the cap mechanism section of the second modification is illustrated.

FIG. 22 is a longitudinal sectional view of a cap mechanism section of a third modification to the cap mechanism section applied to the ink jet printer in FIG. 1, wherein a capping state of the cap mechanism section of the third modification is illustrated.

FIG. 23 is a longitudinal sectional view of a cap mechanism section of a fourth modification to the cap mechanism section applied to the ink jet printer in FIG. 1, wherein a capping state of the cap mechanism section of the fourth modification is illustrated.

FIG. 24 is a longitudinal sectional view of a cap mechanism section of a fifth modification to the cap mechanism section applied to the ink jet printer in FIG. 1, wherein a capping state of the cap mechanism section of the fifth modification is illustrated.

FIG. 25 is a J arrow view of FIG. 24.

FIG. 26 is a longitudinal sectional view of a cap mechanism section of a sixth modification to the cap mechanism section applied to the ink jet printer in FIG. 1, wherein a capping state of the cap mechanism section of the sixth modification is illustrated.

FIG. 27 is a longitudinal sectional view of the cap mechanism section of the modification in FIG. 26, which illustrates an ink sucking state of the cap mechanism section when an internal pressure of the cap has been returned to atmospheric pressure, after ink discharge.

FIG. 28 is a longitudinal sectional view of a cap mechanism section of a seventh modification to the cap mechanism section applied to the ink jet printer in FIG. 1, wherein a capping state of a cap mechanism section of the seventh modification is illustrated.

FIG. 29 is a longitudinal sectional view of the cap mechanism section of the modification in FIG. 28, which illustrates an ink sucking state of the cap mechanism section when a cap has been detached from a print head after ink discharge.

FIG. 30 is a longitudinal sectional view of a cap mechanism section of an eighth modification to the cap mechanism section applied to the ink jet printer in FIG. 1, wherein a capping state of the cap mechanism section of the eighth modification is illustrated.

FIG. 31 is a longitudinal sectional view of the cap mechanism section of the modification in FIG. 30, which illustrates an ink sucking state of the cap mechanism section when a cap has been detached from a print head after ink discharge.

FIG. 32 is a longitudinal sectional view of a cap mechanism section of a ninth modification to the cap mechanism section applied to the ink jet printer in FIG. 1, wherein a capping state of the cap mechanism section of the ninth modification is illustrated.

FIG. 33 is a longitudinal sectional view of the cap mechanism section of the modification in FIG. 32, which illustrates an ink sucking state of the cap mechanism section when a cap has been detached from a print head after ink discharge.

FIG. 34 is a longitudinal sectional view of a cap mechanism section of a tenth modification to the cap mechanism section applied to the ink jet printer in FIG. 1, wherein a capping state of the cap mechanism section of the tenth modification is illustrated.

FIG. 35 is a K arrow view of FIG. 34.

FIG. 36A is a sectional view taken along the Z direction and showing a reversion process of the cap mechanism section of the modification in FIG. 34, wherein a capping state of the cap mechanism section is illustrated; and FIG. 36B shows the cap mechanism section in FIG. 36A in a state where the cap mechanism section is reversed so as to become ready for a maintenance discharge of ink.

### BEST MODE FOR CARRYING OUT THE INVENTION

Hereinafter, an embodiment of the present invention will be described with reference to the drawings.

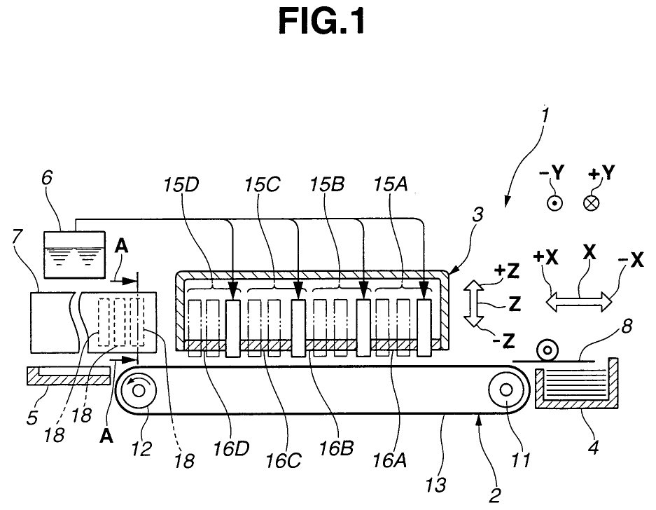

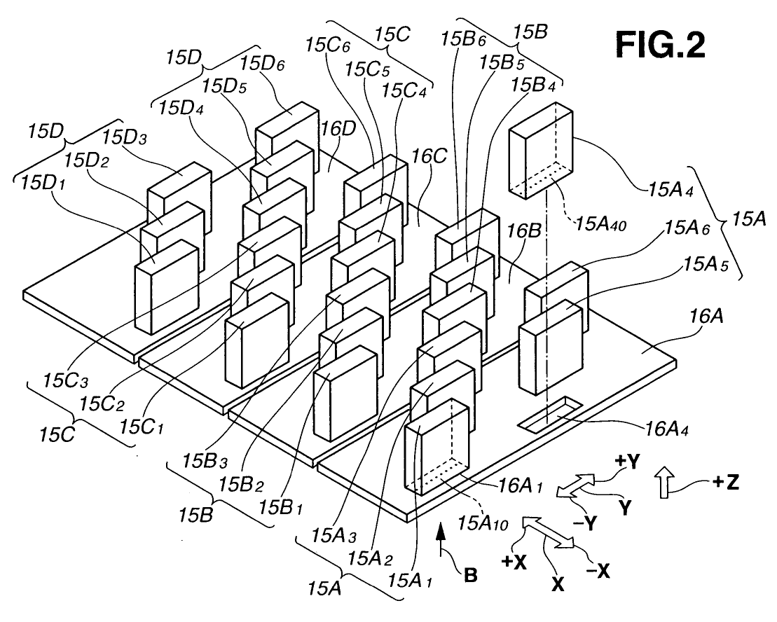

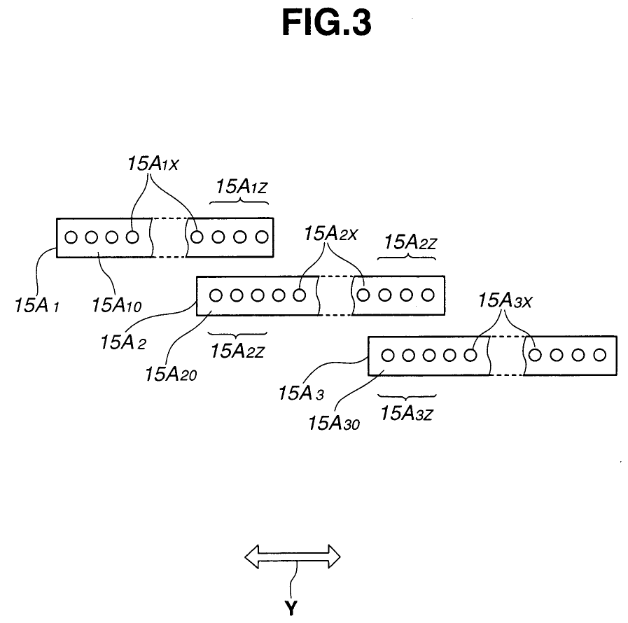

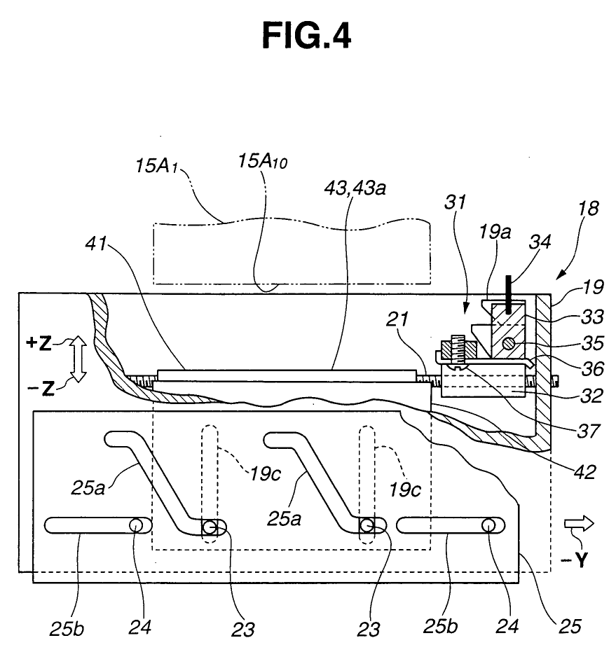

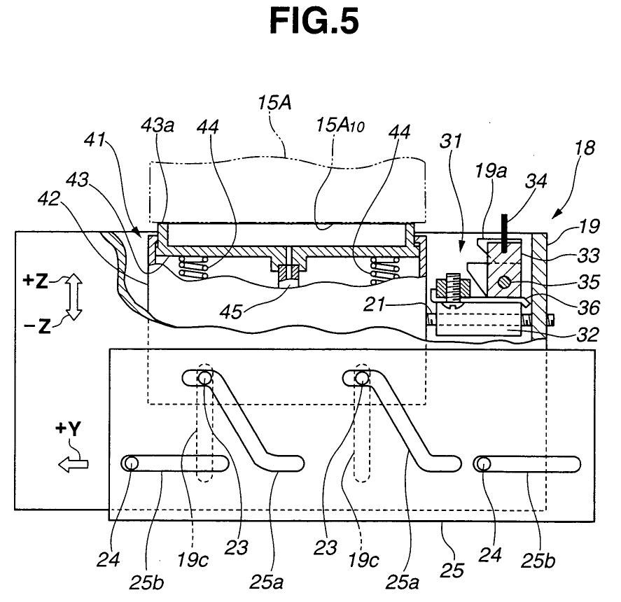

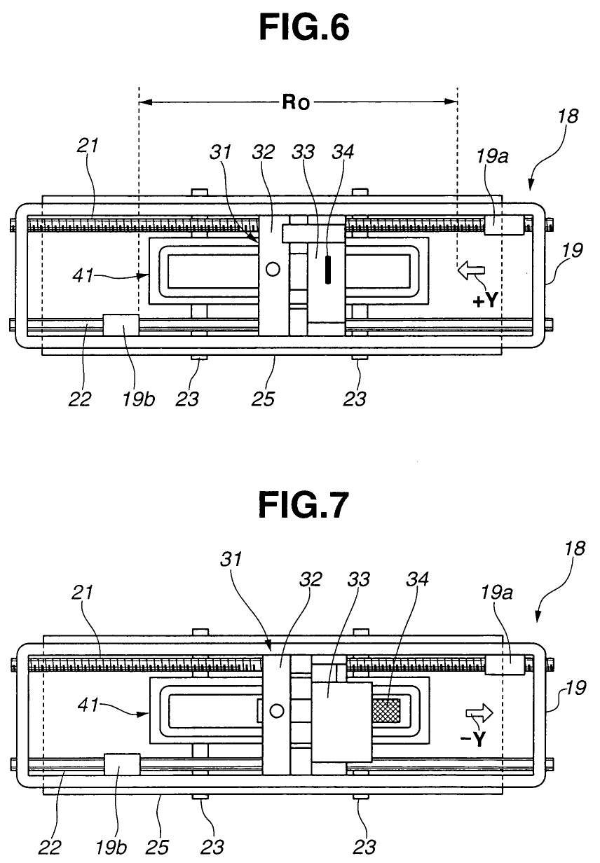

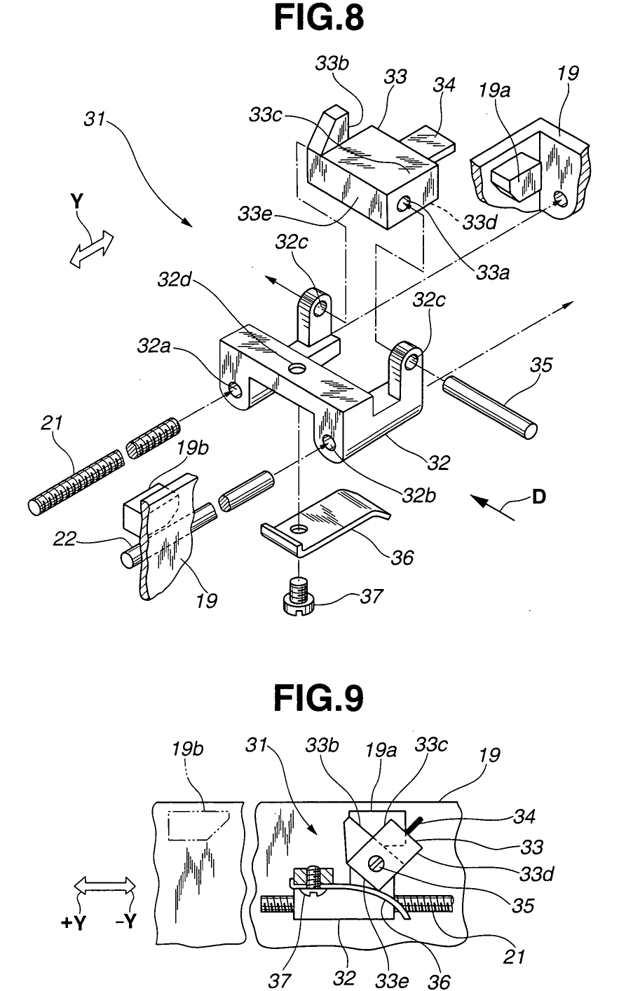

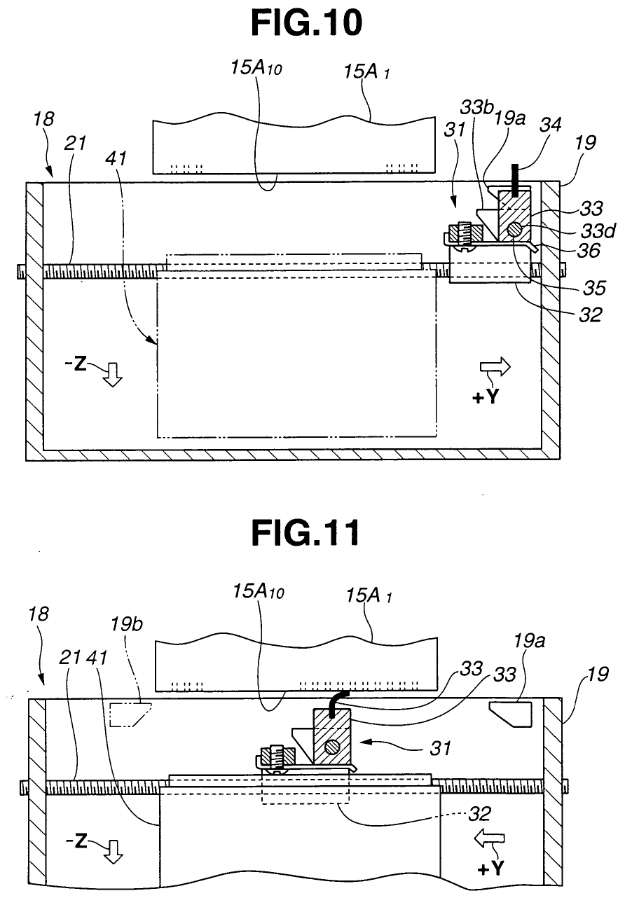

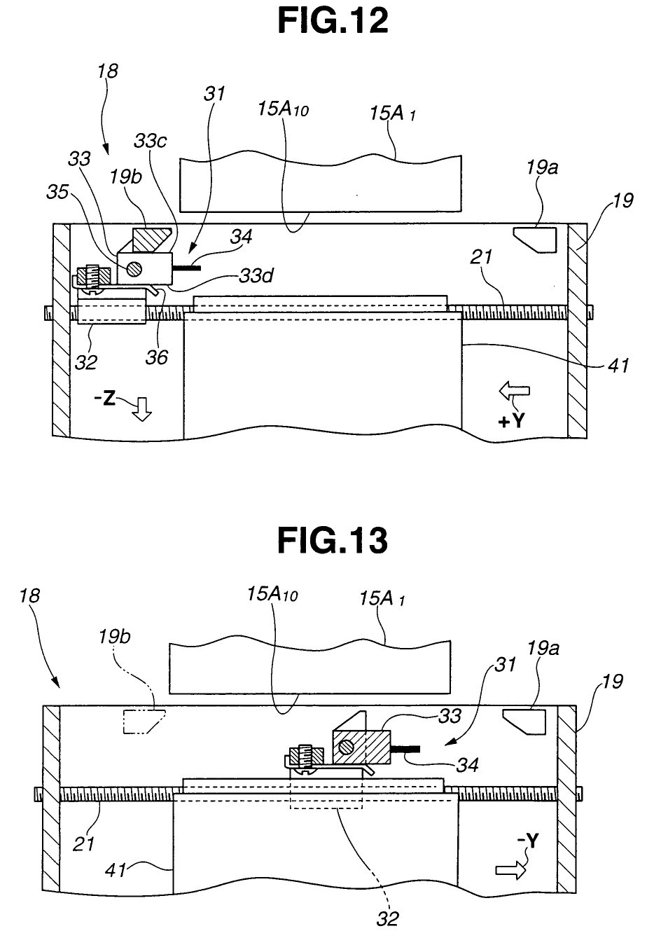

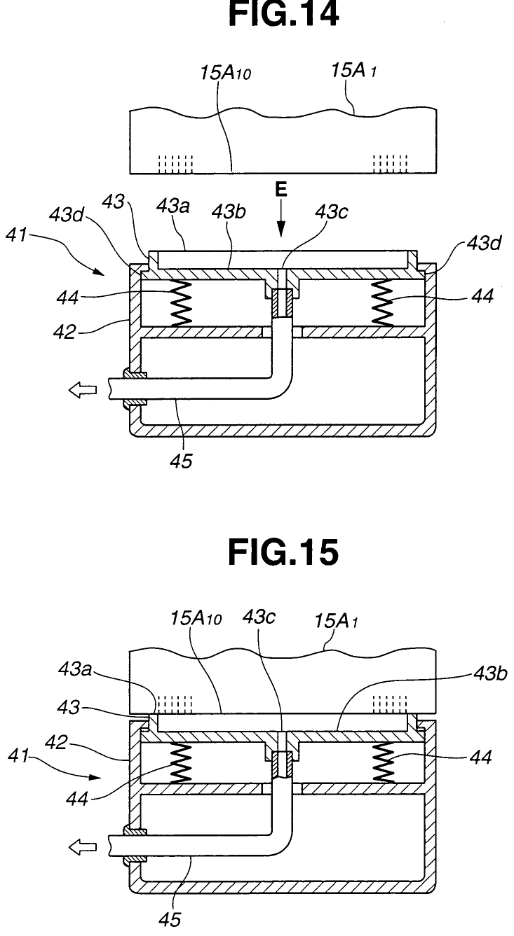

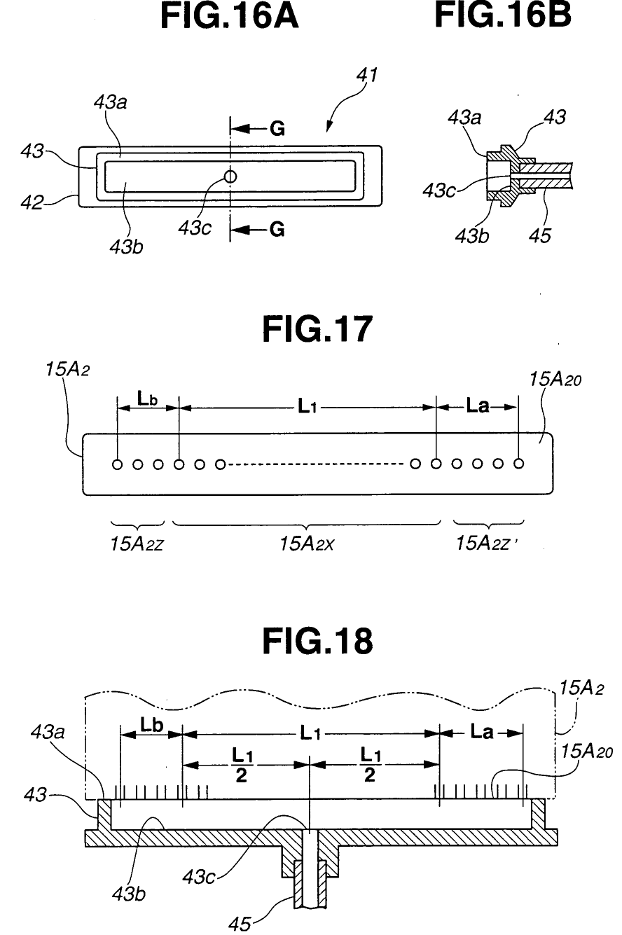

FIG. 1 is a layout view showing the main construction of an ink jet printer according to the embodiment of the present invention. FIG. 2 is an exploded perspective view of a head device applied to the ink jet printer, and FIG. 3 is an enlarged view showing the arrangement of ink discharge nozzle rows when printing heads constituting a head block of the head device of the ink jet printer is seen from the B direction in FIG. 2. FIGS. 4 and 5 are sectional views of a recovery unit of a recovery device incorporated in the ink jet printer, as seen from the A-A direction in FIG. 1. Here, FIG. 4 shows a state in which a wiping mechanism section of the recovery device is located at its retreat position (wiping start position), and in which a cap mechanism section is located at its retreat position, and FIG. 5 shows a state in which the cap mechanism section is located at its capping position. FIGS. 6 and 7 are plan views of the recovery unit, wherein FIG. 6 shows a wiping process, and FIG. 7 shows a wiper returning process. FIG. 8 is an exploded perspective view of the wiper mechanism section of the recovery unit. FIG. 9 is a D arrow view of FIG. 8, wherein a turning movement of a wiper support member in the wiper mechanism section is illustrated. FIGS. 10 to 13 are sectional views in the A-A direction in FIG. 1, illustrating various operational states of the wiper mechanism section. Here, FIG. 10 shows a retreated state of the wiper (wiping start position), FIG. 11 shows a wiping operation, FIG. 12 shows a horizontally retreated state of the wiper, and FIG. 13 shows a returning process of the wiper while remaining in the horizontally retreated state. FIGS. 14 and 15 are longitudinal sectional views of the cap mechanism section of the recovery unit, wherein FIG. 14 shows a retreated state in which the cap mechanism section is retreated from the head, and FIG. 15 shows a capping state in which a cap covers the head. FIG. 16A is an E arrow view of FIG. 14, and FIG. 16B is a G-G sectional view of FIG. 16A. FIG. 17 is an enlarged view illustrating an ink discharge surface to be capped by the cap mechanism section. FIG. 18 is a sectional view of the cap of the cap mechanism that has capped the ink discharge surface.

Here, as the direction of arrangement or movement in the present printer, the upward or downward direction of the device is assumed as Z direction, wherein the upward and downward directions, respectively, are assumed as +Z direction and −Z direction. The horizontal direction along the paper conveying direction is assumed as X direction, wherein the conveying direction and the opposite direction thereto, respectively, are assumed as +X direction and −X direction. The −X direction side is assumed as the upstream side of conveyance, and the +X direction side is assumed as the downstream side of conveyance. The horizontal direction perpendicular to the X direction is assumed as Y direction, wherein the right direction as seen from the upstream side is assumed as +Y direction, and the left direction as seen from the upstream side is assumed as −Y direction.

The ink jet printer 1 according to this embodiment is a printer that performs printing by arranging a plurality of print heads each having a nozzle row discharging ink drops over the entire paper width, and conveying paper in the conveying direction, without causing the print heads to scan in the horizontal directions (the paper width direction and paper conveying direction) during printing.

As shown in FIG. 1, the ink jet printer 1 mainly includes a paper conveying device 2, a head device 3 comprising a plurality of print heads each having a nozzle row discharging ink drops, a paper feed tray 4, a paper discharge tray 5, an ink supply tank 6, and a recovery device 7 that performs recovery processing (maintenance processing), such as cleaning processing and capping processing of the ink discharge surface of the print head. In the cleaning processing, a wiping operation, ink sucking operation, and maintenance discharge operation (ink discharge processing operation for recovery processing) are performed.

The paper conveying device 2 includes a supply side roller 11, a paper discharge side belt drive roller 12, and a conveying belt 13 that conveys paper 8 serving as a printing medium during printing to the horizontal +X direction.

As shown in FIG. 2 (exploded perspective view), the head device 3 comprises head blocks of four colors: a B(black) head block 15A, a C(cyan) head block 15B, an M(magenta) head block-15C, and a Y(yellow) head block 15D. During printing, the head device 3 is held at a fixed position in a state where a predetermined spacing that constitutes an appropriate ink discharge distance is provided on the conveying belt 13 (i.e., non-scan state). At the time of recovery processing, the head device 3 is moved to the +Z direction by a predetermined amount in order to insert the recovery device 7 thereinto.

The B head block 15A is detachably attached to mounting openings 16A1, 16A4, and so on of a head substrate 16A, and includes six print heads 15A1, 15A2, 15A3, 15A4, 15A5, and 15A6 that discharge ink drops in the downward direction. The print heads 15A1, 15A2, and 15A3; and the print heads 15A4, 15A5, and 15A6 are arranged over the entire paper width in dual rows along respective inclined lines inclined with respect to the X direction.

As shown in FIG. 3, on the discharge surfaces 15A10, 15A20, and 15A30 on the bottom of the print heads 15A1, 15A2, and 15A3, ink discharge nozzle rows 15A1x, 15A2x, and 15A3x each of which has a predetermined printing pitch, are provided along the Y direction. The ink discharge nozzle rows 15A1x, 15A2x, and 15A3x include nozzle rows 15A1z and 15A2z that coincide with each other in the Y direction, and nozzle rows 15A2z and 15A3z that coincide with each other in the Y direction. These nozzle rows provided so as to coincide with each other in the Y direction are for accommodating mounting position errors of the print heads in the Y direction.

Similarly, the other print heads of the B head block 15A, that is, 15A4, 15A5, and 15A6 each have a discharge surface with an ink discharge nozzle row, formed on the bottom surface thereof. Therefore, printing of the black color is performed over the entire paper width by the above-described six print heads 15A1 to 15A6, without causing the head block 15A to scan in the horizontal direction (paper width direction).

Likewise, the C head block 15B comprises six print heads 15B1 to 15B6 detachably attached to a head substrate 16B, and these print heads are arranged over the entire paper width along inclined lines inclined with respect to the X direction.

Furthermore, likewise, the M head block 15C comprises six print heads 15C1 to 15C6 detachably attached to a head substrate 16C, and these print heads are arranged over the entire paper width along inclined lines inclined with respect to the X direction.

Moreover, likewise, the Y head block 15D comprises six print heads 15D1 to 15D6 detachably attached to a head substrate 16D, and these print heads are arranged over the entire paper width along inclined lines inclined with respect to the X direction.

The above-described head blocks 15B, 15C, and 15D, respectively, allow printing of the cyan, magenta, yellow colors to be performed over the entire paper width by the respective print heads, without causing the print heads to scan in the paper width direction (horizontal direction). As described above, in this head device 3, since the print heads 15A1, . . . , 15B1, . . . are detachably attached to the head substrates 16A, 16B, . . . , respectively, each of these print heads is replaceable, thereby facilitating the maintenance and repair of the printer device.

The recovery device 7 incorporates therein the respective plural recovery units 18 provided in correspondence to the plurality of print heads 15A1 to 15D6. At the time of recovery processing, the recovery device 7 is moved to the −X direction and is inserted into a lower portion of the head device 3, thereby performing recovery processing of the respective print heads by the incorporated recovery units. Here, the insertion direction of the recovery device 7 is not limited to the −X direction, but the recovery device 7 may be configured to be inserted from the Y direction.

As shown in FIGS. 4, 6, and so on, each of the recovery units 18 includes a unit body 19, a wiping mechanism section 31 serving as wiping means incorporated into the unit body 19, and a capping mechanism section 41 serving as capping means. At the time of recovery processing, each of the recovery units 18 is inserted into a lower portion of a respective one of the print heads 15A1 to 15D6, and performs wiping and capping of the ink discharge surface thereof. Hereinafter, descriptions of the construction and function of the recovery unit 18 are made with respect to the recovery unit 18 corresponding to the print head 15A1. However, the recovery units corresponding to the other print heads have also the same construction and function.

As shown in FIGS. 6 and 8, the wiping mechanism 31 comprises a support member 32 supported by the unit body 19 so as to be movable in the Y direction, a wiper base 33 turnably supported by the support member 32, a wiper 34 serving as an elastically deformable wiper member, and a leaf spring 36 for maintaining the posture of the wiper base 33 supported by the support member 32.

The support member 32 has a female screw 32a and a shaft hole 32b, and is supported by a feed screw shaft 21 and a guide shaft 22 that, respectively, are engaged with and inserted into the female screw 32a and the shaft hole 32b so as to be slidable with respect to the unit body 19 in the Y direction.

The wiper base 33 has a shaft hole 33a, and is turnably supported by shaft holes 32c of the support member 32 via a support shaft 35 inserted into the shaft hole 33a.

The wiper 34 is adhered to the front end of the wiper base 33, and is turningly moved by the turning of the wiper base 33 to an uprising position (FIG. 10), which projects upward from the unit body 19 and which allows the wiper 34 to perform wiping, and to a horizontal retreat position (FIG. 12), at which the wiper 34 is housed in the unit body 19 in a non-wiping state.

In order to turn the wiper base 34 to the above-described uprising position and horizontal retreat position, the wiper base 33 includes an abutting surface 33c that is a side surface portion thereof parallel to the surface of the wiper 34, and an abutting surface 33b provided on a protrusion protruding beside the abutting surface 33c. The abutting surface 33b is a plane perpendicular to the surface of the wiper 34 and the abutting surface 33c.

As shown in FIGS. 6 and 7, at the end portion in the −Y direction and +Y direction on the inner wall surface of the top surface opening portion of the unit body 19, there are provided protuberances 19a and 19b, respectively. When the wiping mechanism section 31 moves, the protuberances 19a and 19b abut against the abutting surfaces 33b and 33c of the wipe base 33, and thereby turningly drive the wiper base 33.

The leaf spring 36 is attached to a concave surface situated at a lower portion of the support member 32 by a screw 37, and the front end thereof abuts against the bottom surface 33e of the wiper base 33 or the side surface 33d thereof, whereby the leaf spring 36 click-holds the wiper base 33 and the wiper 34 in an uprising state or a horizontal retreated state.

FIG. 9 shows a switching state in which the wiper 34 supported by the wiper base 33 turns from a horizontal posture to an uprising posture. Thereafter, when the wiper base 33 counterclockwise turns, the leaf spring 36 abuts against the bottom surface 33e, and consequently, as shown in FIGS. 4 and 10, the wiper base 33 and the wiper 34 uprise in the Z direction, and the uprising posture is click-held. Conversely, when the wiper base 33 clockwise turns, the leaf spring 36 abuts against the side surface 33d, and consequently, the horizontal retreated posture of the wiper base 33 and the wiper 34 in the Y direction as shown in FIG. 12, is click-held.

As shown in FIGS. 4 to 7, the cap mechanism section 41 includes a cap support frame 42, a cap 43 serving as a cap member supported by the cap support frame 42, two cap energizing springs 44, and a suction tube 45. Here, only the frame portion of the head-abutting surface 43a of the cap 43 may be formed of silicon rubber or the like, in order to improve the adhesive property thereof.

The cap mechanism section 41 is supported at the central portion of the unit body 19 so as to be movable in the Z direction, and is driven in the Z direction (vertical direction) by a drive plate 25 supported by the unit body 19 so as to be slidable in the Y direction.

The drive plate 25 is supported by guide grooves 25b each fitted on a pin 24 of the unit body 19 so as to movable in the Y direction. Also, the cap mechanism section 41 is supported by pins 23 of the cap support frame 42 each fitted into a Z direction guide groove 19c of the unit body 19 so as to be movable in the Z direction. The pins 23 of the cap support frame 42 are each fitted in an inclined groove 25a of the drive plate 25. As a result, with the moving of the drive plate 25 in the Y direction, the cap mechanism section 41 moves to a lower housing position (FIG. 4) in the unit body 19, and to an upper position therein (FIG. 5) allowing a capping operation.

As shown in FIGS. 14 and 15, the cap 43 is guided and supported by the cap support frame 42 so as to be relatively movable in the Z direction. When the cap support frame 42 is located at an upper position together with the cap mechanism section 41 (FIGS. 5 and 15), the head-abutting surface 43a on the top surface of the cap 43 abuts along the print head 15A1 under an energizing force of the two cap energizing springs 44, and caps the ink discharge surface 15A10 of the print head 15A1. When the cap mechanism section 41 is located at the lower housing position, a flange portion 43d of the cap 43 abuts against the cap support frame 42, thereby preventing deviation of the cap 43 to the upward direction.

At substantially the central portion of a concave cap surface 43b, which is a head-facing surface of the cap 43 and which faces the print head during capping, there is provided an ink suction hole 43c for sucking maintenance-discharged ink (i.e., ink discharged for recovery processing) during recovery processing. The ink suction hole 43c has a suction tube 45 connected thereto.

Strictly speaking, the position of the ink suction hole 43c located on the cap surface 43b, is substantially the central position equidistant from the opposite ends of the nozzle area of a corresponding print head in the nozzle row direction (i.e., the longitudinal direction, or the Y direction).

Here, the case of the cap 43 corresponding to the print head 15A2 will be taken as an example. As shown in FIG. 17, the print head 15A2 has the effective nozzle area L1 except dummy nozzle areas La and Lb that are located at both outside end portions of the nozzle row area 15A2x of the print head 15A2, and that do not participate in the actual printing. Then, the ink suction hole 43c provided in the cap surface 43b of the cap 43 is disposed in the central position of the nozzle area L1, the central position dividing L1 into two equal parts L₁/2, as shown in FIG. 18. The disposition of the ink suction hole 43c in this manner allows all ink discharged in the cap to be sucked without unevenness.

When performing recovery processing using the recovery units 18 with the above-described arrangements, the head device 3 is moved to the +Z direction into a non-printing state. The recovery device 7 is inserted into the lower portion of the head device 3. In the inserted state of the recovery device 7, each of the recovery units 18 is located at the lower portion of a respective one of the print heads.

While the operation of the recovery unit corresponding to the print head 15A1 is described below, the operation of the recovery unit corresponding to each of the other print heads such as 15A2, . . . is the same.

When inserting the recovery device 7 into the lower portion of the head device, as shown in FIGS. 10 and 12, in the recovery unit 18, either the support member 32 of the wiping mechanism section 31 is retreated at the end of the unit body 19 in the −Y direction (FIGS. 4 and 10), or the wiper 34 is laid to the horizontal retreat position at the end in the +Y direction (FIG. 12). In addition, the cap mechanism section 41 is lowered to the lower retreat position within the unit body 19.

When performing the capping of the print head 15A1 with the recovery device 7 inserted into the lower portion of the head device, the drive plate 25 is driven in the −Y direction, and the cap frame 42 of the cap mechanism section 41 is moved upward in the +Z direction. In this raising process, because the wiping mechanism section 31 is at the retreat position shown in FIG. 4 (FIG. 10), or that shown in FIG. 12, the cap mechanism section 41 can pass through a wiping moving area RO (FIG. 6), which is the moving area of the wiper 34 of the wiping mechanism section 31. The head-abutting surface 43a of the cap 43 supported by the cap frame 42 is abutted against the discharge surface 15A10 of the print head into capping state (FIGS. 5 and 15).

When attempting to keep the printer apparatus 1 in a non-printing state for a long period, the print head is kept in a capped state by the cap 34 to prevent the drying of the ink discharge surface. When cleaning processing of the ink discharge surface 15A10 of the print head is to be performed, ink is sucked from the discharge nozzle hole by bringing the inside of the cap to a negative pressure via the cap 43.

When attempting to perform maintenance discharge operation, first, the ink discharge surface 15A10 is brought into a capping state by the cap 43. For this purpose, the drive plate 25 is driven in the −Y direction, and the cap frame 42 of the cap mechanism section 41 is moved upward in the +Z direction. As shown in FIG. 4 or 10, in this raising process, because the wiping mechanism section 31 is retreated at the end of the unit body 19 in the Y direction in advance, the cap mechanism section 41 can pass through the wiping moving region R0 (FIG. 6). The head-abutting surface 43a of the cap 43 supported by the cap frame 42 is abutted against the discharge surface 15A10 of the print head into a capping state (FIGS. 5 and 15).

In this capping state, ink for cleaning the nozzles of the print head is discharged into the cap 43. In other words, a maintenance discharge is performed. The discharged ink is ejected to the outside by the suction tube 45 through the ink suction hole 43c.

With the recovery unit 18 inserted into the lower portion of the head device, the drive plate 25 is driven in the +Y direction. By this movement of the drive plate 25, the cap mechanism section 41 is lowered to the lower housing position of the unit body 19, and the ink discharge surface 15A10 of the print head is brought into an open state (FIGS. and 10). This state allows the wiping mechanism section 31 to become ready to move in the wiping moving area R0 (FIG. 6) along the Y direction.

Accordingly, when the wiping mechanism section 31 is in the horizontal retreated state in FIG. 12, the above-described feed screw shaft 21 is rotationally driven to move the wiping mechanism section 31 in the −Y direction, as shown in FIG. 13. During this movement, the wiper 34 is kept in the horizontal posture. Upon arrival of the wiper base 33 of the wiping mechanism section 31 at the end of the unit body 19 in the −Y direction, the protuberances 19a of the unit body 19 abuts against the abutting surface 33b of the wiper base 33, and press it. As a consequence, as shown in FIG. 9, the wiper base 33 turns, and the wiper 34 is switched into the uprising posture, which allows the wiper 34 to wipe the ink discharge surface 15A10 of the print head.

Thereafter, when the feed screw 21 is driven in the reverse rotational direction, the support member 32 of the wiping mechanism section 31 moves along the +Y direction as shown in FIG. 11, and the wiper 34 moves in the wiping moving area R0 shown in FIG. 6, thus performing wiping of the ink discharge surface 15A10.

When the wiping of the ink discharge surface 15A10 has completed and the support member 32 of the wiping mechanism section 31 arrives at a wiping completion position adjacent to the +Y side end of the unit body 19, the protuberance 19b of the unit body 19 abuts against the abutting surface 33c of the wiper base 33 and presses it. As a consequence, as shown in FIG. 12, the wiper base 33 falls down in the horizontal direction, and the wiper 34 is switched into the horizontal posture, resulting in the retreated state.

After the completion of the above-described series of recovery processing operations, the cap mechanism section 41 and the wiping mechanism section 31 are moved to the retreat position with respect to the unit body 19, as shown in FIG. 12. Under this retreated state, the recovery device 7 is retreated from the lower portion of the head device 3 in the +X direction. Then, the head device 3 is lowered in the −Z direction into a state ready for printing.

The above-described ink jet printer according to the present embodiment is configure so that, during recovery processing, the wiping mechanism section 31 and the cap mechanism section 41 are alternately movable with respect to the ink discharge surface of each of the print heads. Specifically, during a wiping operation, the cap mechanism section 41 is kept on standby below the wiping moving area R0 of the wiper, and the wiping mechanism section 31 is brought into a state ready to slidingly move. On the other hand, during a capping operation or a maintenance discharge operation, the wiping mechanism section 31 has been retreated at the end of the moving area, and therefore, the cap mechanism section 41 stands ready to move upward and cap the ink discharge surface of the print head.

As described above, one portion of the moving areas of the cap mechanism section 41 and the wiping mechanism section 31 is shared between these two sections as seen from the ink discharge direction, and therefore, space-saving has been achieved. For a large-sized ink jet printer that needs to arrange a plurality of small heads to form a large head, for example, a page-width printer apparatus in which caps and wipers are arranged at respective separate positions as usual, it is inevitable to considerably upsize the apparatus. However, as described above, by allowing the shared use of the one portion of the moving areas of the cap mechanism section 41 and the wiping mechanism section 31 between these two sections, the downsizing of the entire printer apparatus can be realized.

Furthermore, since the ink suction hole provided in the cap 43 of the cap mechanism sections 41 is disposed at a position equidistant from the opposite ends of the nozzle area on the cap surface in the longitudinal direction (i.e., nozzle row direction), it is possible to more reliably suck all ink maintenance-discharged.

Next, first to tenth modifications to the cap mechanism section of the ink jet printer 1 according to the above-described embodiment will be described. Here, the constructions of mechanism members other than a cap mechanism member, such as a wiper mechanism section, in an ink jet printer into which a cap mechanism section of any one of the aforementioned modifications is to be incorporated, are assumed to be the same as the constructions of those in the above-described embodiment.

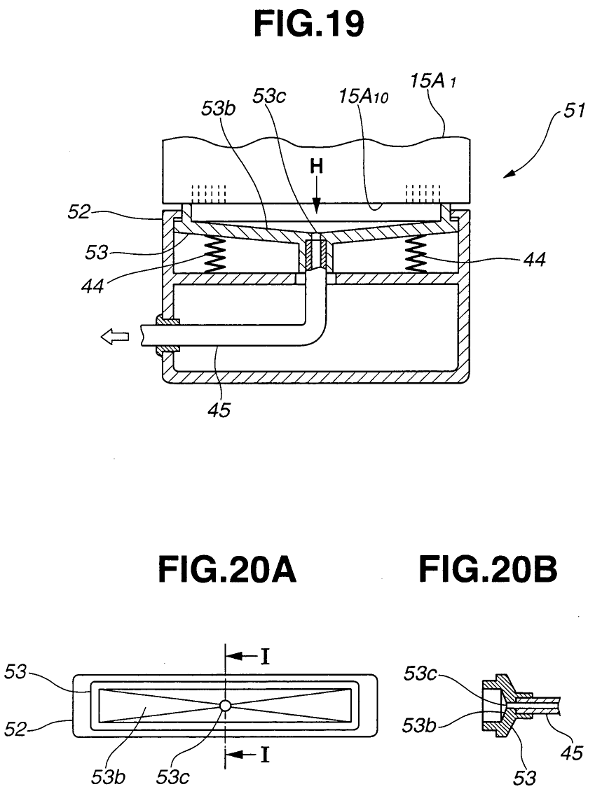

FIG. 19 is a longitudinal sectional view of a cap mechanism section of a first modification to the cap mechanism section of the above-described ink jet printer 1, wherein a capping state or a maintenance-discharging state is illustrated. FIG. 20A is an H arrow view of FIG. 19, and 20B is a I-I sectional view of FIG. 20A.

As shown in FIG. 19, the cap mechanism section 51 of this modification comprises a cap support frame 52, a cap 53 supported by the cap support frame 52 and serving as a cap member, two cap energizing springs 44, and a suction tube 45.

A cap surface 53b that is a head-facing surface of the cap 53, constitutes an concave inclined surface opposed to the print head, and has an ink suction hole 53c provided in the central portion of the cap surface 53b in the nozzle row direction (i.e., the longitudinal direction of the head). As shown in FIGS. 20A and 20B, the cap surface 53b is inclined so that the ink suction hole 53c portion assumes the lowest position.

According to the cap mechanism section 51 of the first modification, since the cap surface 53b of the cap 53 is constituted of an inclined surface as described above, ink maintenance-discharged in the cap 53 during recovery processing is quickly ejected from the suction hole 53c without its residue, and thereby reliable recovery processing is performed.

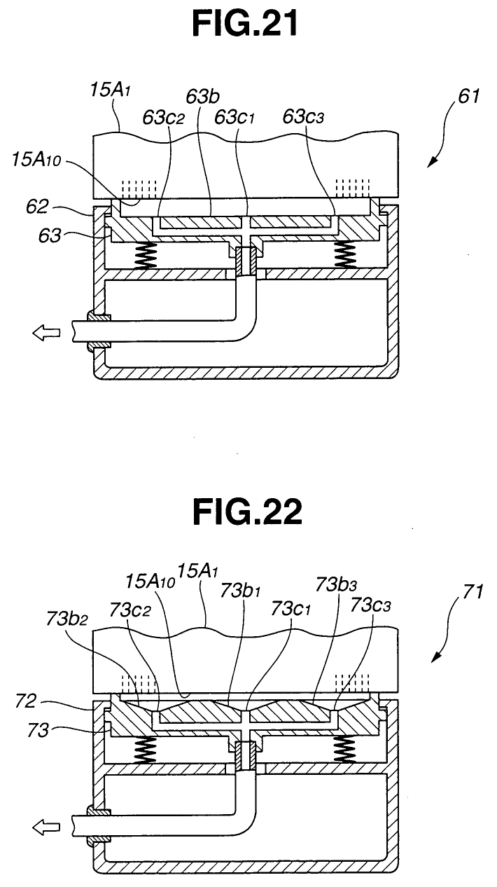

FIG. 21 is a longitudinal sectional view of a cap mechanism section of a second modification to the cap mechanism section of the ink jet printer 1, wherein a capping state or a maintenance discharge state is illustrated.

As shown in FIG. 21, the cap mechanism section 61 of this modification comprises a cap support frame 62, a cap 63 supported by the cap support frame 62 and serving as a cap member, two cap energizing springs, and a suction tube.

A cap surface 63b that is a head-facing surface of the cap 63, constitutes an concave inclined surface opposed to the print head, and has a plurality of ink suction holes 63c1, 63c2, and 63c3 provided in the cap surface along the nozzle row direction (i.e., the longitudinal direction of the head).

According to the cap mechanism section 61 of the second modification, since a plurality of ink suction holes is provided in the cap surface 63b of the cap 63 as described above, ink maintenance-discharged in the cap 63 during recovery processing is quickly ejected, thereby allowing recovery processing in a short time.

FIG. 22 is a longitudinal sectional view of a cap mechanism section of a third modification to the cap mechanism section of the ink jet printer 1, wherein a capping state or a maintenance discharge state is illustrated.

As shown in FIG. 22, the cap mechanism section 71 of this modification comprises a cap support frame 72, a cap 73 supported by the cap support frame 72 and serving as a cap member, two cap energizing springs, and a suction tube.

A cap surface that is a head-facing surface of the cap 73, constitutes an concave inclined surface opposed to the print head, and has a plurality of ink suction holes 73c1, 73c2, and 73c3 provided in the cap surface along the nozzle row direction (i.e., the longitudinal direction of the head). Moreover, the cap surface is inclined toward each of the ink suction holes 73c1, 73c2, and 73c3, and is formed of inclined surfaces 73b1, 73b2, and 73b3 where the respective suction holes assumes the lowest positions.

According to the cap mechanism section 71 of the third modification, since a plurality of ink suction holes is provided in the cap surface of the cap 73 as described above, and further a surface inclined toward each of the ink suction holes is provided, ink maintenance-discharged in the cap 73 during recovery processing is quickly ejected, thereby allowing recovery processing in a short time.

FIG. 23 is a longitudinal sectional view of a cap mechanism section of a fourth modification to the cap mechanism section of the ink jet printer 1, wherein a capping state or a maintenance discharge state is illustrated.

As shown in FIG. 23, the cap mechanism section 81 of this modification comprises a cap support frame 82, a cap 83 supported by the cap support frame 82 and serving as a cap member, two cap energizing springs, and a suction tube.

A cap surface 83b that is a head-facing surface of the cap 83, constitutes a concave inclined surface opposed to the print head, and has an ink suction hole 83c provided in the central position on the cap surface. Furthermore, the cap surface 83b has thereover an ink absorbing member 84 formed of sponge.

According to the cap mechanism section 81 of the fourth modification, since an ink absorbing member is provided over the cap surface 83b of the cap 83 as described above, ink maintenance-discharged in the cap 83 during recovery processing can be accommodated therein without flying, and ejected.

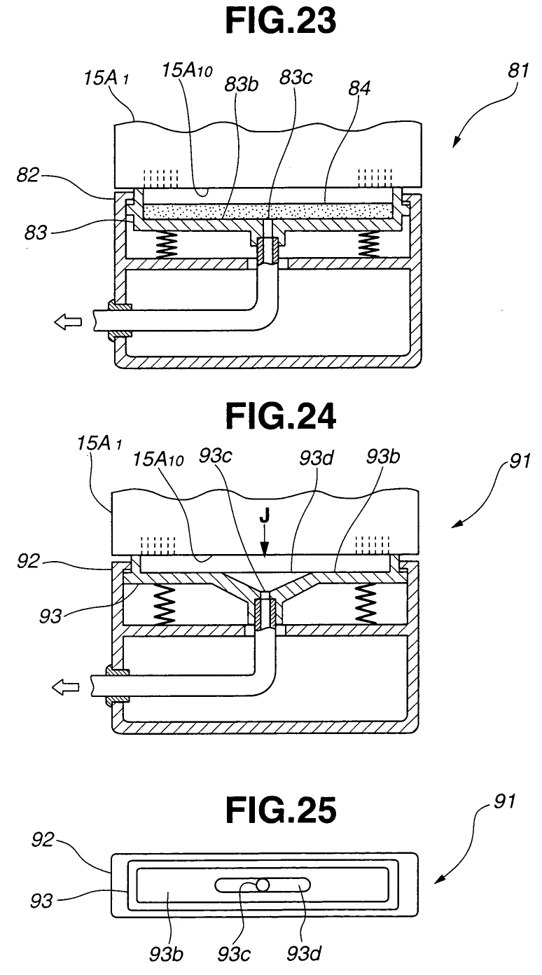

FIG. 24 is a longitudinal sectional view of a cap mechanism section of a fifth modification to the cap mechanism section applied to the ink jet printer 1, wherein a capping state or a maintenance discharge state is illustrated. FIG. 25 is a J arrow view of FIG. 24.

As shown in FIG. 24, the cap mechanism section 91 of this modification comprises a cap support frame 92, a cap 93 supported by the cap support frame 92 and serving as a cap member, two cap energizing springs, and a suction tube.

A cap surface 93b that is a head-facing surface of the cap 93, constitutes a concave inclined surface opposed to the print head. As shown in FIG. 25, a long groove (long hole) 93d is provided in the central position of the cap surface along the nozzle row direction (i.e., the longitudinal direction of the head), and an ink suction hole (through hole) 93c is provided in the central portion of the long groove 93d. The bottom surface of the long groove 93d is inclined downward toward the ink suction hole 93c.

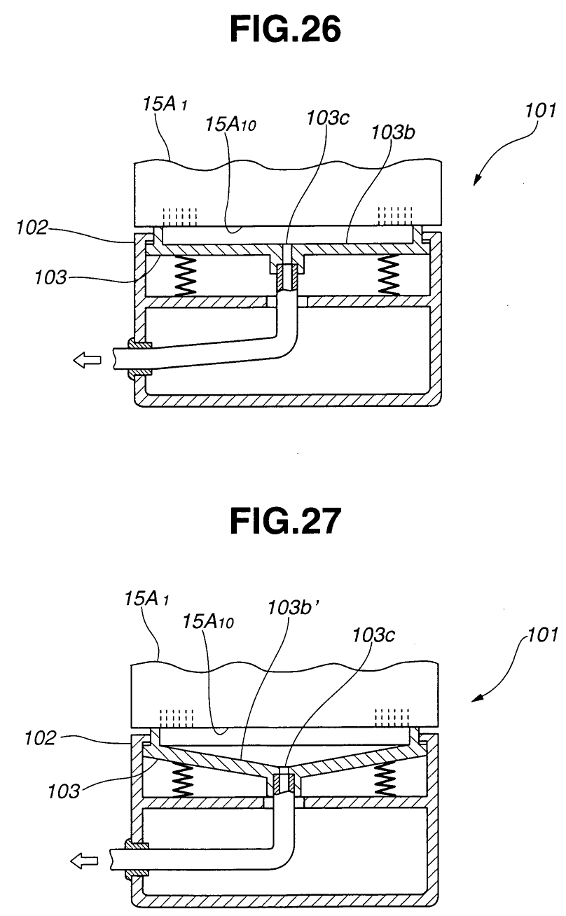

FIG. 26 is a longitudinal sectional view of a cap mechanism section of a sixth modification to the cap mechanism section applied to the ink jet printer 1, wherein a capping state or a maintenance discharge state is illustrated. FIG. 27 is a longitudinal sectional view of the aforementioned cap mechanism section, which illustrates an ink sucking state when the internal pressure of the cap has been returned to atmospheric pressure, after ink discharge.

As shown in FIG. 26, the cap mechanism section 101 of this modification comprises a cap support frame 102, a cap 103 supported by the cap support frame 102 and serving as a cap member formed of silicone rubber or the like, two cap energizing springs, and a suction tube.

A cap surface 103b that is a head-facing surface of the cap 103, constitutes an concave inclined surface opposed to the print head, and has an ink suction hole 103c provided in the central portion of the cap surface in the nozzle row direction (i.e., the longitudinal direction of the head).

In the cap mechanism section of this modification 101, during ink discharge and suction operations, the cap 103 closely adheres to the ink discharge surface 15A10 of the print head, and the pressure inside the cap 103 becomes a negative pressure. As a result, as shown in FIG. 26, the cap surface 103b of the cap 103 is lifted upward, thereby forming a substantially horizontal surface. After the completion of the maintenance discharge operation, a suction piping system is opened. The opening of the suction piping system returns the pressure inside the cap 103 to atmospheric pressure. As a consequence, the cap surface 103b returns to the original shape with the cap 103 closely adhered to the ink discharge surface 15A10. The original shape of the cap surface 103b refers to a shape of an inclined cap surface 103b′ such that the ink suction hole 103c assumes the lowest position, as shown in FIG. 27.

According to this modification, therefore, maintenance-discharged ink is quickly sucked from the ink suction hole 103c along the inclined cap surface 103b′, thereby allowing recovery processing in a short time.

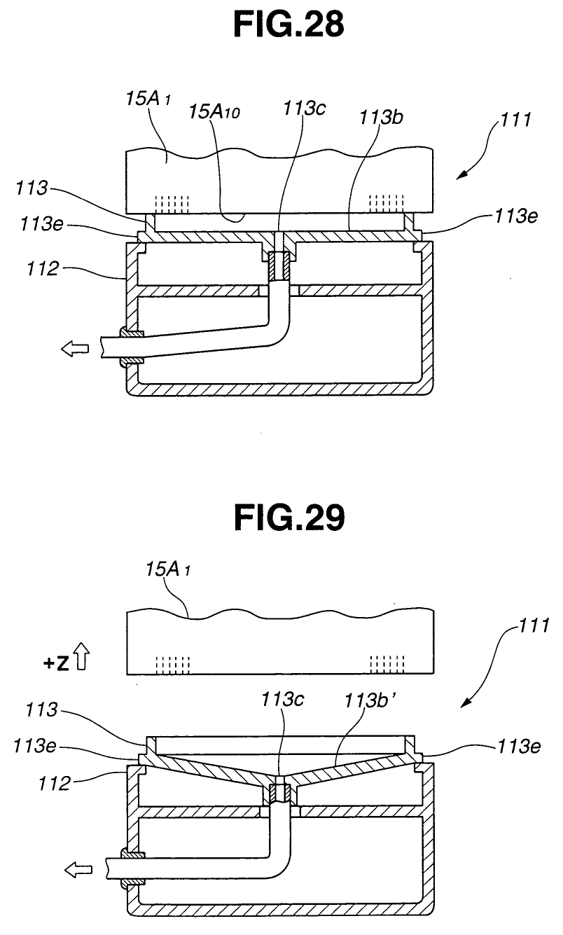

FIG. 28 is a longitudinal sectional view of a cap mechanism section of a seventh modification to the cap mechanism section applied to the ink jet printer 1, wherein a capping state or a maintenance discharge state is illustrated. FIG. 29 is a longitudinal sectional view of the aforementioned cap mechanism section, which illustrates an ink sucking state when the cap has been detached from the print head after ink discharge.

As shown in FIG. 28, the cap mechanism section 111 of this modification comprises a cap support frame 112, a cap 113 supported by the cap support frame 112 and serving as a cap member formed of silicone rubber or the like, and a suction tube.

A cap surface 113b that is a head-facing surface of the cap 113, constitutes an concave inclined surface opposed to the print head, and has an ink suction hole 113c provided in the central portion of the cap surface in the nozzle row direction (i.e., the longitudinal direction of the head).

In the cap mechanism section of this modification 111, during ink discharge and suction operations, the cap 113 closely adheres to the ink discharge surface 15A10 of the print head, and the pressure inside the cap 113 becomes a negative pressure. As a result, as shown in FIG. 28, the head-facing surface 113b of the cap 113 is lifted upward, thereby forming a substantially horizontal surface. However, after a maintenance discharge operation, when the cap 113 is detached from the ink discharge surface 15A10 of the print head into an open state, the cap surface 113b returns to the original shape by this opening of the cap. The original shape of the cap surface 113b refers to a shape of an inclined cap surface 113b′ such that the ink suction hole 113c assumes the lowest position, as shown in FIG. 29.

According to this modification, therefore, a maintenance-discharged ink is quickly sucked from the ink suction hole 113c along the inclined cap surface 113b′, thereby allowing recovery processing in a short time.

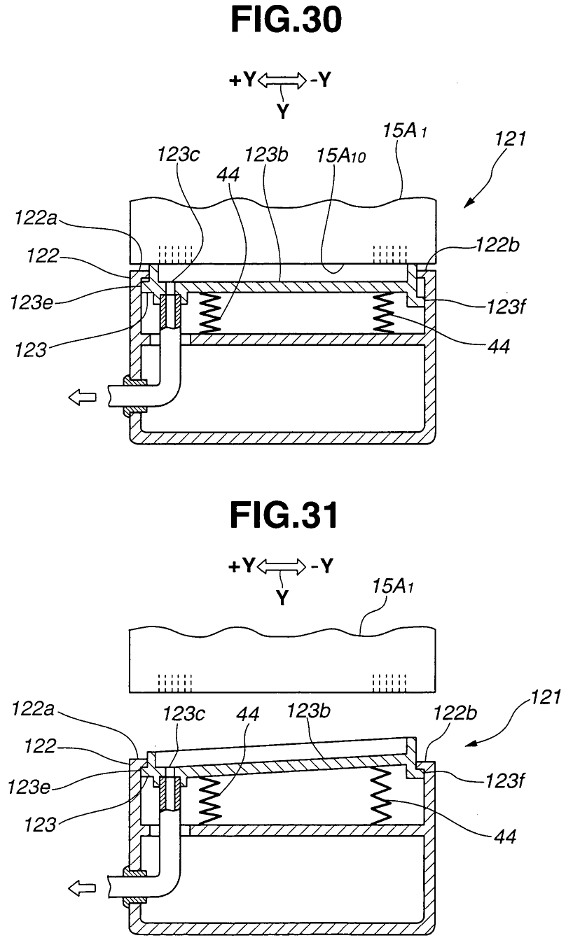

FIG. 30 is a longitudinal sectional view of a cap mechanism section of an eighth modification to the cap mechanism section applied to the ink jet printer 1, wherein a capping state or a maintenance discharge state is illustrated. FIG. 31 is a longitudinal sectional view of the aforementioned cap mechanism section, which illustrates an ink sucking state when a cap has been detached from the print head after ink discharge.

As shown in FIG. 30, the cap mechanism section 121 of this modification comprises a cap support frame 122, a cap 123 supported by the cap support frame 122 and serving as a cap member, two cap energizing springs 44, and a suction tube.

A cap surface 123b that is a head-facing surface of the cap 123, constitutes an concave inclined surface opposed to the print head, and has an ink suction hole 123c provided at the end in the +Y direction of the cap surface in the nozzle row direction (i.e., the longitudinal direction of the head).

At the opposite ends of the cap 123 in the +Y and −Y directions, there are provided projections 123e and 123f, respectively, capable of abutting against abutting portions 122a and 122b on the inner surface of the cap support frame 122.

During ink discharge and suction operations in recovery processing, in a capping state where the cap 123 is abutted against the ink discharge surface 15A10 as shown in FIG. 30, the cap surface 123b is kept horizontal. In this state, the spacing between the aforementioned projection 123f and abutting portion 122b at the end in the −Y direction is set to be larger than that between the aforementioned projection 123e and abutting portion 122a at the end in the +Y direction. After the completion of the maintenance discharge of ink, when the cap 123 leaves the print head 15A as shown in FIG. 31, the cap 123 moves upward under an energizing force of the two cap energizing springs 44, and the end in the −Y direction moves to a position higher than the end in the +Y direction. As a result, the cap surface 123b of the cap 123 is inclined downward toward the +Y side, and the ink suction hole 123c is held at the lowest position. Maintenance-discharged ink is quickly ejected from the ink suction hole 123c along the cap inclined surface 123b.

According to the cap mechanism section 121 of this modification, ink discharged during recovery processing is quickly sucked from the ink suction hole 123c along the inclined cap surface 123b, thereby allowing recovery processing in a short time.

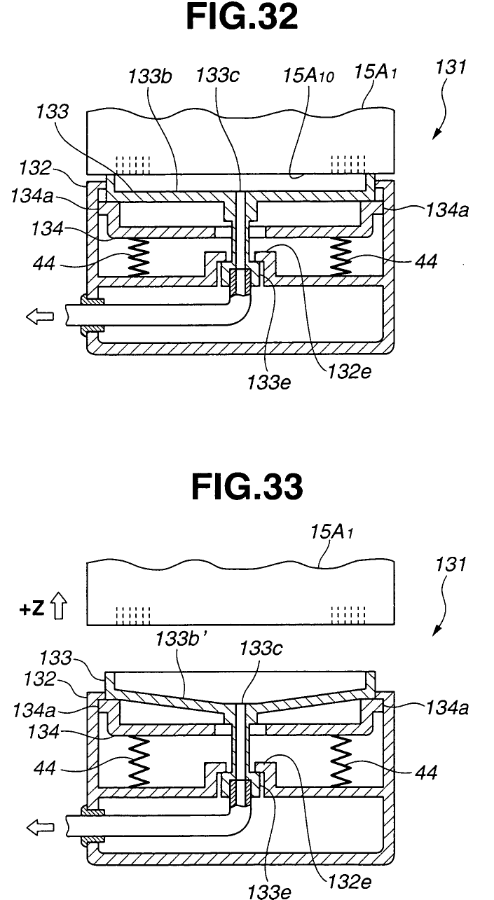

FIG. 32 is a longitudinal sectional view of a cap mechanism section of a ninth modification to the cap mechanism section applied to the ink jet printer 1, wherein a capping state or a maintenance discharge state is illustrated. FIG. 33 is a longitudinal sectional view of the aforementioned cap mechanism section, which illustrates an ink sucking state when a cap has been detached from the print head after ink discharge.

As shown in FIG. 32, the cap mechanism section 131 of this modification comprises a cap support frame 132, a cap 133 supported by the cap support frame 132 and serving as a cap member formed of silicone rubber or the like, a pressing plate 134 for pressing the cap 133 toward the print head side and supported slidably in the cap support frame, two cap energizing springs 44 for pressing the cap 133 upward via the pressing plate 134, and a suction tube.

A cap surface 133b that is a head-facing surface of the cap 133, constitutes an concave inclined surface opposed to the print head, and has an ink suction hole 133c provided in the central portion of the cap surface in the nozzle row direction (i.e., the longitudinal direction of the head).

A flange portion 133e is provided below the ink suction hole 133c of the cap 133, and restricts the movement of the cap 133 in the upward direction (+Z direction), by abutting against a stopper 132e of the cap support frame 132. As shown in FIG. 32, during ink discharge and suction operations in recovery processing, the cap 133 abuts against the ink discharge surface 15A10 of the print head 15A1, thereby keeping the cap surface 133b horizontal.

After the completion of the ink discharge operation, when the cap mechanism section 131 is lowered to release the cap 133 from the ink discharge surface 15A10, the cap 133 is moved to the +Z direction via the pressing plate 134 by an energizing force of the two cap energizing springs 44, as shown in FIG. 33. With this movement, the cap surface 133b around the ink suction hole 133c is relatively pulled to the −Z direction. As a result, the cap surface 133b constitutes an inclined surface 133b′ such that the surroundings of the ink suction hole 133c assume the lowest position. Thereby, maintenance-discharged ink is quickly ejected from the ink suction hole 133c along the inclined cap surface 133b′.

According to the cap mechanism section 131 of the ninth modification, ink discharged during recovery processing is quickly sucked from the ink suction hole 133c along the inclined cap surface 133b′, thereby allowing recovery processing in a short time.

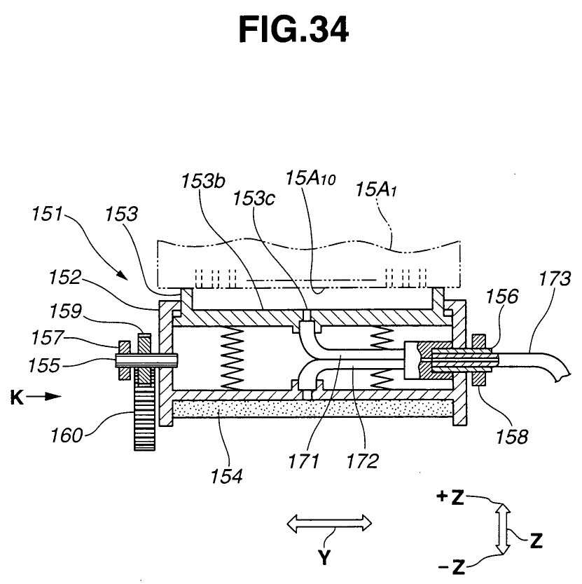

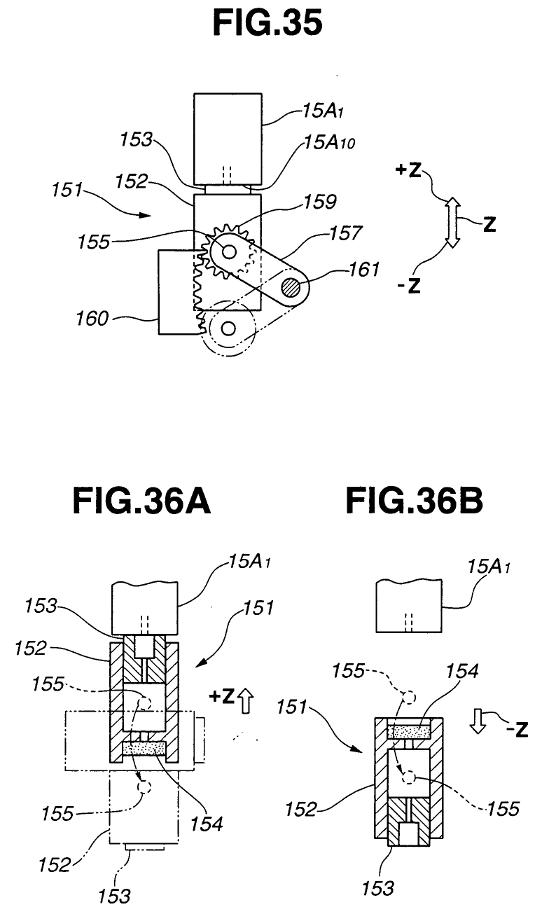

FIG. 34 is a longitudinal sectional view of a cap mechanism section of a tenth modification to the cap mechanism section applied to the ink jet printer 1, wherein a capping state is illustrated. FIG. 35 is a K arrow view of FIG. 34. FIGS. 36A and 36B are sectional views taken along the Z direction, wherein a reversing process of the aforementioned cap mechanism section is illustrated. Here, FIG. 36A shows a capping state, and FIG. 36B shows a state. in which the aforementioned cap mechanism section is reversed so as to become ready for a maintenance discharge of ink.

As shown in FIG. 34, the cap mechanism section 151 of this modification is formed of a cap support frame 152, a cap 153 serving as a cap member for capping the print head, and a sponge member. The cap mechanism section 151 includes an ink absorbing section 154 serving as an ink receiving portion for absorbing maintenance-discharged ink, two cap energizing springs 44 for pressing upward the cap 153, a pair of drive levers 157 and 158 adhered to a lever support shaft 161 and integrally driven by a cap mechanism section drive system (not shown), a sector-shaped internal gear 160 fixedly supported, and suction tubes 171 to 173. Here, only the frame portion of a head-abutting surface at an upper portion of the cap 153 is formed of silicon rubber or the like, in order to improve the adhesive property thereof.

The cap 153 is supported by the support frame 152 so as to be movable relative thereto in the Z direction (vertical direction). The cap 153 has an ink suction hole 153c formed in a cap surface 153b that is a head-facing surface. The ink suction hole 153c communicates with an external suction tube 173 via the suction tube 171.

The ink absorbing section 154 is provided, within the cap support frame 152, in a recess located opposite to the cap 153 in the Z direction, and contains a sponge-like member. An ink suction hole provided in the ink absorbing section 154 communicates with the external suction tube 173 via the suction tube 172.

The cap support frame 152 has support shaft portions 155 and 156 that are provided at opposite ends thereof and at the respective substantially middle positions thereof in the Z direction so as to project along opposite sides in the Y direction, the support shaft portion 155 being adhered to the support frame, and the support shaft portion 156 being capable of rotating relative to the support shaft portion 155. Here, the support shaft portion 156 is arranged so that its rotation relative to a printer apparatus body (not shown) is regulated.

A pinion 159 engaging with the sector-shaped internal gear 160 is adhered to the support shaft portion 155, and also the front end of the aforementioned drive lever 157 is turnably fitted on the support shaft portion 155. A suction tube 173 is inserted into the inner periphery of the support shaft portion 156, and the front end of the drive lever 158 is fitted on the outer periphery of the support shaft portion 156 in a turnable state.

The recovery processing operation in the cap mechanism section 151 with the above-described features will now be described. First, when the ink discharge surface 15A10 of the print head 15A1 is to be capped in order to prevent the nozzles of the print head 15A in a non-printing state from drying, the drive levers 157 and 158 are clockwise turned. Thereupon, the cap 153 moves in the +Z direction, and abuts against the ink discharge surface 15A10, thereby performing capping (FIGS. 35 and 36). In this capping state, ink is discharged. The discharged ink is sucked and ejected via the suction tubes 171 and 173.

In order to perform wiping of the ink discharge surface 15A10 using the wiper mechanism section 31, it is necessary to lower the cap mechanism section 151 into a retreated state, and to oppose the above-described ink absorbing section 154 to the ink discharge surface 15A10. For this purpose, the drive levers 157 and 158 are counterclockwise turned. By the turning of the drive lever 157, the pinion 159 goes down together with the support shaft portions 155 and 156 while rotating on its axis along the internal gear 160. The cap support frame 152 goes down to the retreat position in the −Z direction while rotating along the revolution locus of the pinion 159, and stops (FIGS. 35 and 36B). In this descending state, the ink discharge surface 15A10 is released from the cap 153, and the cap support frame 152 has been turned by an angle of 180 degrees from the capping position, and consequently, the ink absorbing section 154 becomes opposed to the ink discharge surface 15A10 of the print head 15A.

In the retreated state of the cap 153, the wiper mechanism section 31 (FIG. 4) becomes ready to slidingly move in the wiping moving area R0 shown in FIG. 6, and cleaning of the ink discharge surface 15A10 is performed by the wiper 34.

In the retreated state of the wiper 34 of the wiper mechanism section 31, and simultaneously in the open state of the ink discharge surface 15A10, when ink is discharged from the nozzle row of the print head 15A1 toward the ink absorbing section 154, a maintenance discharge is performed.

According to the cap mechanism section 151 of the tenth modification, effects similar to those in the above-described embodiment are achieved.

The structure of the cap mechanism section of each of the above-described first to tenth modifications is applicable to a cap mechanism section for a long-length type head. With respect to the long-length type head, maintenance-discharged ink can be efficiently sucked.

### Industrial Applicability

As described above, according to the recovery device for an ink jet printer according to the present invention, since the recovery device can be disposed so that the wiping means and the cap means partially overlap each other with respect to the print head, the occupation area of the recovery device is reduced, and thereby allowing the size-reduction of the printer apparatus to be achieved. Also, by integrating the ink receiving section for receiving ink during ink discharge, with the cap means, further space-saving can be implemented. Furthermore, in the case of the head in which ink is discharged downward, ink accumulated within the cap can be reliably sucked from the ink suction hole. Particularly with respect to a long-length type head that is capable of page-width printing, it is possible to efficiently suck ink.

1. A recovery device for an ink jet printer, comprising:
wiping means that wipes each of ink discharge surfaces of print heads that discharge ink; and
cap means that caps each of the ink discharge surfaces,
wherein the recovery device is disposed so that the wiping means and the cap means at least partially overlap each other, as seen from the ink discharge direction of the print head.

2. The recovery device for an ink jet printer according to claim 1, wherein:
the cap means comprises a cap section that caps the ink discharge surface of the print head, and an ink receiving section disposed on the opposite side of the cap and having an ink absorbing member for receiving ink discharged by the print head for recovery processing;
when the cap means caps the ink discharge surface of the print head, the cap means is configured so that the cap section is located at a capping position opposed to the ink discharge surface of the print head; and
when the ink discharge surface is wiped by the wiping means, the cap means is configured so that the cap section is located at a retreat position spaced apart from the ink discharge surface, and that the ink receiving section is opposed to the ink discharge surface.

3. A recovery device for an ink jet printer, comprising:
a cap member capable of covering an ink discharge surface of a print head that discharges ink in a downward direction,
wherein, in the cap member, an ink suction hole for sucking ink discharged on the surface of the cap member opposite to the print head is disposed in equal position with respect to a nozzle area of the print head.

4. The recovery device for an ink jet printer according to claim 3, wherein the ink suction hole is disposed in substantially the central portion of the nozzle area of the print head in the longitudinal direction.

5. The recovery device for an ink jet printer according to claim 3, wherein a plurality of the ink suction holes is arranged along the longitudinal direction of the nozzle area of the print head.

6. The recovery device for an ink jet printer according to claim 3, wherein the ink suction hole has an oblong hole shape extending along the longitudinal direction of the nozzle area of the print head.

7. A recovery device for an ink jet printer, comprising:
a cap capable of covering an ink discharge surface of a print head that discharges ink in a downward direction,
wherein the cap has an ink suction hole for sucking ink discharged or sucked on the surface of the cap opposite to the print head; and
wherein an inclined surface such that the ink suction hole portion assumes the lowest position on the surface of the cap opposed to the print head during at least one period of time in a sucking process by the cap, is formed on the surface of the cap opposed to the head.

8. The recovery device for an ink jet printer according to claim 7, wherein the print head of the ink jet printer is a fixed type print head that does not move in a horizontal direction at least during printing.

9. The recovery device for an ink jet printer according to any one of claims 7 and 8, wherein, in a state where the cap has capped the ink discharge surface of the print head, the cap has an inclination formed at at least one portion of the surface thereof opposed to the print head so that the ink suction hole assumes the lowest position on the surface of the cap opposed to the print head.

10. The recovery device for an ink jet printer according to any one of claims 7 and 8, wherein, in a state where the cap is retreated at a retreat position with respect to the print head, an inclined surface that is inclined with respect to the ink suction hole, is formed on the surface of the cap opposed to the print head.

11. The recovery device for an ink jet printer according to any one of claims 7 and 8, wherein each of the inclined surfaces of the respective one of the caps is formed by deforming the surface of the cap opposed to the print head.

12. The recovery device for an ink jet printer according to any one of claims 7 and 8, wherein, in the cap, at least one portion within the cap is inclined so that the ink suction hole assumes the lowest position.
